(19) United States
(12) Patent Application Publication
(10) Pub. No.: US 2005/0258613 A1
(43) Pub. Date: Nov. 24, 2005

(54) Control arm for a vehicle suspension and method of making same

(76) Inventor: Matthew D. Kleckner, Commerce Township, MI (US)

Correspondence Address: Burgess Law Office, PLLC, P.O. Box 214320, Auburn Hills, MI, 48321-4320, US

(21) Appl. No.: 10/850,566

(22) Filed: May 20, 2004

(51) Int. Cl. B60G 1/00

(52) U.S. Cl. 280/124.107; 280/124.156; 280/124.116

(57) ABSTRACT

A control arm for use with a vehicle suspension having first and second elongated channel sections. Each of the channel sections including an upper flange portion, a lower flange portion and a web portion combined to form a substantially C-shaped cross-section. The web portion further having an indentation or recess extending longitudinally along the length of the respective channel sections, the indentation or recess creating a protrusion or rib member in the web portion and acts as a strengthening member providing additional rigidity to the first and second elongated channel sections. The channel sections are placed adjacent and connected at the respective web portions. An isolator, such as a compressible or flexible member is secured to the respective first and second ends of the connected first and second channel sections.

### 1. FIELD OF THE INVENTION

A control arm or linking member of the type used as part of a vehicle suspension system to connect an axle to a vehicle frame, and more specifically, a control arm having two sections secured together in a configuration that provides stiffness and strength to the control arm.

### 2. BACKGROUND OF THE INVENTION

Modern automotive vehicles may utilize a multitude of different suspension systems designed to: attach and support the wheels of a motor vehicle on the motor vehicle body or frame; to maintain proper wheel alignment and location of the wheels as the vehicle travels over various surfaces; to stabilize the vehicle during maneuvering; and, to absorb and isolate the occupants from road shock to provide a comfortable ride.

Over time, many different types of vehicle suspension systems have been developed to provide performance in the above-identified areas. One design includes the use of a control or trailing arm to connect a vehicle axle to a vehicle frame. The control or trailing arm locates the axle with respect to the vehicle frame and operates to provide stability and proper wheel alignment during maneuvering of the vehicle.

Prior art control arms include elongated tubular members of various cross sections. In addition, two-piece control arms, wherein the control arm includes two separate members that twist or move independently of one another, are also known.

In addition, the cost of a vehicle component, such as a control arm, is always a concern to vehicle manufacturers. Accordingly, vehicle component manufacturers are always looking to manufacture a quality product at a reduced cost. Typically, control arms are made from roll or tubular stock which must be cut and formed into the desired shape. In addition, use of roll or tubular stock requires additional work to complete construction of the control arm by requiring some type of support be attached to the roll or tubular stock to receive the bushings or isolators that are used to connect the control arm to both the axle and the vehicle frame.

Thus, it is desirable to have a control arm having a configuration that provides the stiffness and strength necessary to provide stability and proper wheel alignment during maneuvering of the vehicle and also reduces the work necessary to manufacture the control arm.

### SUMMARY OF THE INVENTION

The present invention provides a control arm for use as part of a vehicle suspension. In the preferred embodiment, the present control arm includes a first elongated channel section having an upper flange portion, a lower flange portion and a web portion forming a substantially C-shaped cross-section. The first and second ends of the first elongated channel section each include apertures extending transversely through the web portion. A second elongated channel section having an upper flange portion, a lower flange portion and a web portion forming a substantially C-shaped cross-section and further having first and second ends each including apertures extending transversely through the web portion is placed adjacent to the first elongated channel section.

The respective web portions of the first and second elongated channel sections are connected to one another. In addition, the respective apertures located at the first and second ends of the channel are aligned and receive an isolator that is positioned and secured within the aligned apertures at the first and second ends.

In addition, the web portion may include an indentation, recess or indentation on the inner side thereof deflecting at least a part of the web portion outwardly and forming a strengthening rib or protrusion which adds rigidity and strength to the first and second elongated channel sections.

Further, the invention provides a method for forming a control arm for use with a vehicle suspension including the steps of forming a pair of elongated members, each of said members having an upper flange, a lower flange and a web portion having an indentation recess or indentation formed on the inner side thereof. Positioning elongated members such that the respective web portions of each of said pair of elongated members are placed adjacent to one another and secure said elongated members to one another. Once the pair of elongated members are secured to one another, an isolator is inserted into apertures located at the first and second ends of the elongated members.

In one embodiment of the invention, the isolators are press fit into the apertures located at the first and second ends of the elongated members.

### BRIEF DESCRIPTION OF THE DRAWINGS

FIG. 1 is a schematic view of a vehicle rear axle and suspension system utilizing a control arm according to the present invention.

FIG. 2 is a perspective view of a control arm according to the present invention.

FIG. 3 is a top view of the control arm of FIG. 2.

FIG. 4 is a front view of the control arm of FIG. 2.

FIG. 5 is a cross-sectional view of the control arm of FIG. 3 taken along lines 5-5.

FIG. 6 is a cross-sectional view of the control arm of FIG. 3 taken along lines 6-6.

FIG. 7 is a front view of an alternative embodiment of a control arm according to the present invention.

FIG. 8 is a cross-sectional view of the control arm of FIG. 7 taken along lines 8-8.

### DETAILED DESCRIPTION OF THE INVENTION

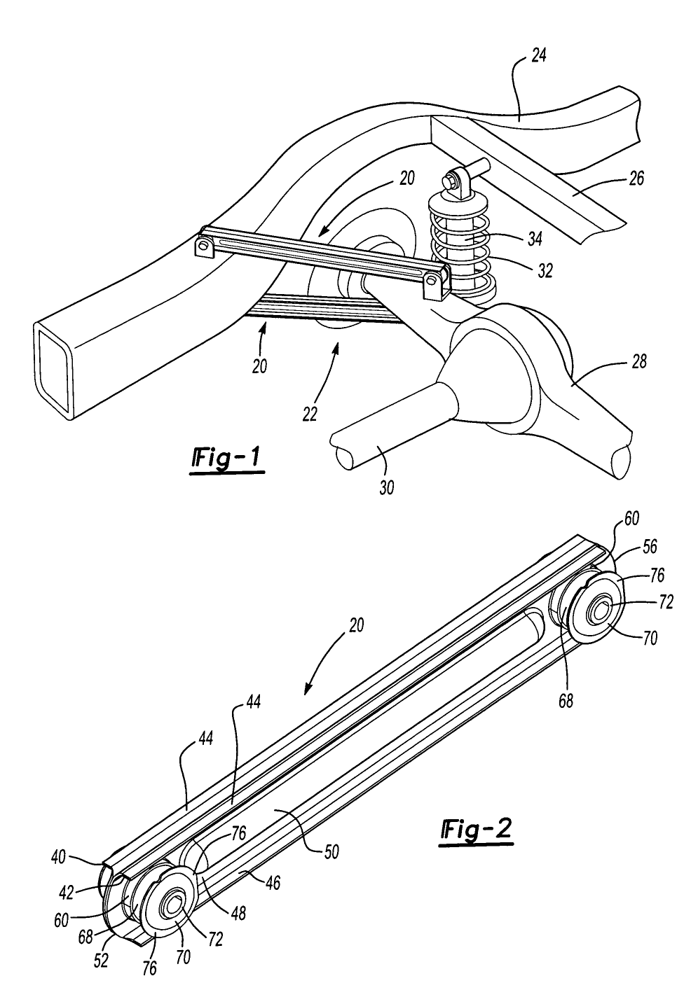

Turning to FIG. 1, a control arm 20 according to the present invention is shown in use with a rear suspension system, a portion of which is seen generally at 22, of a motor vehicle (not shown). It should be understood that one side of the rear suspension system 22 is shown, with the other side or other portion being substantially identical. In general, the vehicle includes a frame member 24 and a cross-member 26 which interconnects respective frame members. A rear axle 28 receiving power from a drive shaft 30 is connected to the frame member 24 by the rear suspension system 22.

The rear suspension system 22 may include a coil spring 32 disposed between and attached on one end to the rear axle 28 and on the other end to the cross member 26. A shock absorber 34 may be disposed, as shown, within the coil spring 32. The shock absorber operates to dampen the energy of the coil spring 32 stored during absorption of road shock occurring during operation of the vehicle. As shown in FIG. 1, a pair of control arms 20 according to the present invention is connected to the upper surface and lower surfaces of the frame member 24 and rear axle 28 respectively.

Turning to FIGS. 2-6, the control arm 20 according to the present invention is shown in greater detail. The control arm 20 includes first and second elongated channel sections 40, 42. The channel sections 40, 42 are C-shaped including upper and lower flange portions 44, 46 and a center web portion 48 wherein the flange portions 44, 46 extend laterally from the web portion 48. As shown, the transition between the flange portions 44, 46 and the web portion 48 may be sloped or curved to reduce stress at the flange portion 44, 46 and web portion 48 interface.

The web portion 48 also includes a semi-circular indentation or recess 50 extending longitudinally along the first and second elongated channel sections 40, 42. The center of the semi-circular indentation or recess 50 is typically located at the midpoint of the web portion 48; that is, equally spaced from the upper and lower flange portions 44, 46. As shown in FIG. 6, the semi-circular indentation or recess 50 is formed on the inner side 47 of the web portion 48 by deforming the web portion 48 to urge a part of the web portion 48 outwardly in the same direction as the flange portions 44, 46. Accordingly, the indentation or recess 50 forms a longitudinal, semi-circular protrusion or rib which adds rigidity to the elongated channel sections 40, 42. As shown, the indentation or recess tapers inwardly toward the web portion 48 as it nears the first and second ends of the elongated channel sections 40, 42 to provide a smooth transition.

Each of the elongated channel sections 40, 42 has first and second ends 52, 56. Each of said first and second ends 52, 56 include an aperture 58 in the web portion 48. In the preferred embodiment, the aperture 58 is cylindrical, extends transversely through the web portion 48 and includes a circumferential flange member 60 extending outwardly from the web portion 48 in the same direction as the flange portions 44, 46.

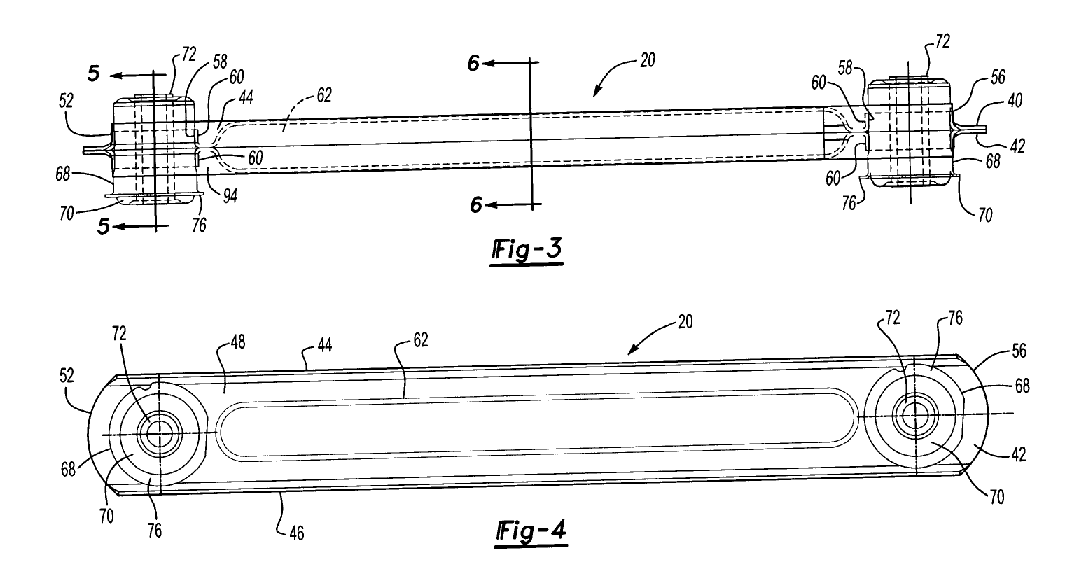

As shown in FIGS. 3-6 the control arm 20 is formed by placing they elongated channel sections 40, 42 in a back-to-back relationship wherein the respective web portions 48 are placed adjacent one another. When the channel sections 40, 42 are positioned with the respective web portions 48 placed adjacent one another, the respective flange portions 44, 46 extend outwardly from both sides of the adjacent web portions 48. The semi-circular indentations or recesses 50 formed on each of the web portions 48 cooperate to form a cylindrically shaped passageway 62 that extends longitudinally along at least a portion of the control arm 20.

In addition, when the first and second elongated channel sections 40, 42 are placed adjacent one another, the respective apertures 58 located in the first and second ends 52, 56 of the first channel section 40 are aligned with the apertures on the first and second ends 52, 56 of the second channel section 42 to form a single aperture at each of the first and second ends 52, 56 of the control arm 20.

The first and second elongated channel sections 40, 42 are secured to one another in the back-to-back relationship typically through welding. Specifically, the web portions 48 of the first and second channel sections 40, 42 are spot welded at spaced points along the respective channel sections 40, 42. Other types of fastening or coupling means may be used, such as rivets, threadable fasteners or other mechanical fastening means. In addition, the first and second channel sections 40, 42 may also be welded together at the upper and lower flange/web interfaces 64.

Accordingly, as shown in FIG. 6, when fastened together, the first and second channel sections 40, 42 cooperate to form a control arm 20 having an I-beam construction with a tubular strengthening passageway 62 extending along at least a portion of the length of the control arm 20 to provide additional rigidity and greater resistance to buckling or bending loads occurring in the control arm 20 during the vehicle operation.

Referring to FIGS. 3-5, an isolator, seen generally at 66, is shown secured in the apertures 58 of the first and second ends 52, 56 of the control arm 20. The isolator 66, as broadly construed, includes a flexible or compressible member typically made of an elastomeric material such as rubber. In the preferred embodiment, an outer bushing or sleeve 68 is disposed over a flexible member 70. An inner bushing or sleeve 72 is disposed within an aperture 74 located in the flexible member 70. The inner bushing or sleeve 72 receives a pivot pin, bolt or other fastening member used to secure the control arm 22 to either the frame member 24 or the axle 28.

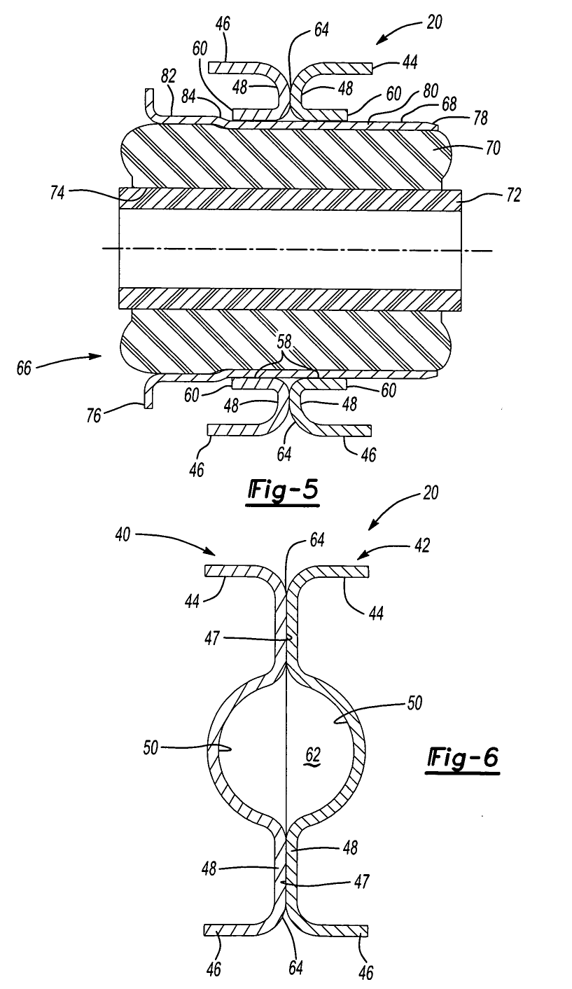

As shown in greater detail in FIG. 5, the outer bushing or sleeve 68 includes an outwardly extending radial flange member 76 located on one end thereof. On the opposite end thereof, the outer bushing or sleeve 68 includes a beveled edge or lead in surface 78. A portion of the outer bushing or sleeve 68 has a first diameter 80 slightly greater than the aperture 58 in the first and second ends 52, 56 of the channel sections 40, 42. The outer bushing or sleeve 68 further includes a second or increased diameter portion 82 which is greater than the first diameter 80 and correspondingly forms a shoulder 84 at the junction of the first and second diameters 80, 82.

The reason the first diameter 80 is slightly greater than the aperture 58 is that the outer bushing or sleeve 68 is press fit into the aperture 58 formed by the circumferential flange members 60 on the first and second ends 52, 56 of the first and second channel sections 40, 42. A suitable tool engages the flange member 76 of the outer bushing or sleeve 68 and is used to apply the necessary force to press the isolator assembly 66 into the aperture 58 until the shoulder 84 of the outer bushing or sleeve 68, which provides a locating surface, engages the circumferential flange member 60 on the first channel section of 40.

In the preferred embodiment, the first and second channel sections 40, 42 are formed by stamping separately the respective first and second channel sections 40, 42 from steel blanks. Thus, first and second pieces of flat sheet stock are placed either individually or side-by-side in a stamping die which then, through the stamping process, forms the respective first and second channel sections 40, 42. Once stamped, the first and second channel sections 40, 42 are placed in the side-by-side relationship wherein the respective web portions 48 are positioned adjacent one another. Once positioned adjacent one another, the first and second channel sections 40, 42 are spot welded together. Once the channel sections 40, 42 are welded together, the isolator assemblies 66 are then pressed into the apertures 58 in the first and second ends 52, 56 of the control arm 20.

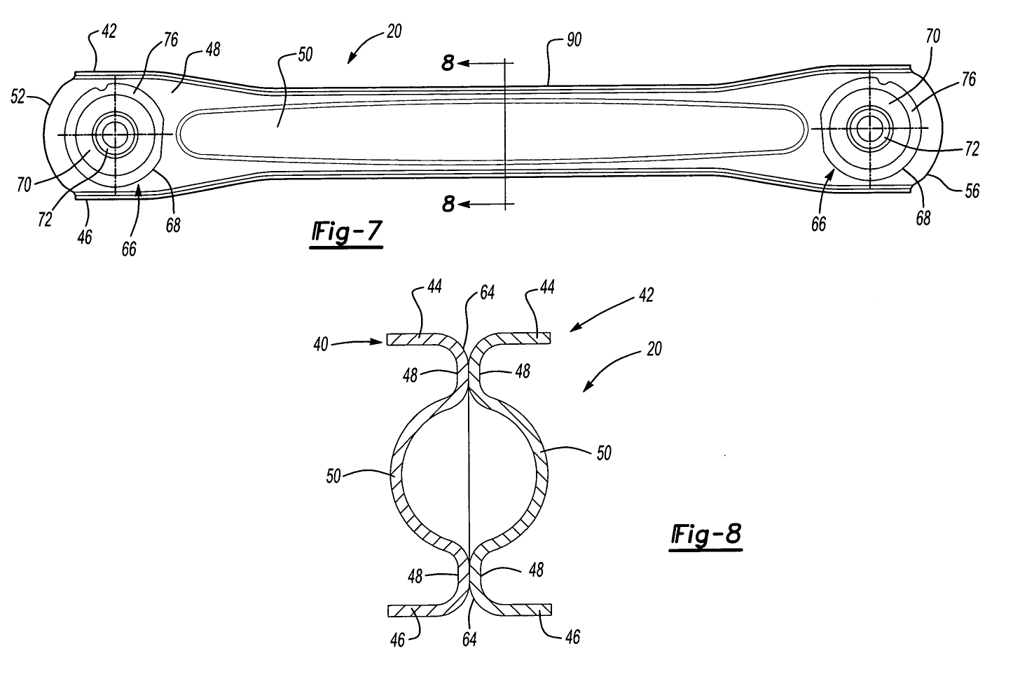

Turning to FIGS. 7-8, there is shown an alternative embodiment of the control arm 20 according to the present invention to wherein the height of the web portion 48 is reduced at the center or middle portion 90 of the control arm 20. In addition, the indentation or recess 50 varies in shape along the length of the first and second elongated channel sections 40, 42 and the size of the indentation or recess 50 is greater at the center or middle portion 90 of the control arm 20 then at the first and second ends 52, 56 thereof. As with the previous embodiment, the indentation or recess, and correspondingly the protrusion in the web portion 48 created thereby, tapers inwardly toward the web portion 48 to provide a smooth transition between the web portion 48 and the indentation or recess 50 forming the strengthening rib or protrusion.

Accordingly, it should be understood that the height of the web portion 48, along with the size and shape of the indentation or recess 50 formed in the web portion 48, may be varied depending upon the required strength and rigidity needed for the particular use and specifications of a particular control arm 20.

It will thus be seen that the objects of the invention have been fully and effectively accomplished. It will be realized, however, that the foregoing specific embodiments have been shown and described for the purposes of illustrating the functional and structural principles of the invention and is subject to change without departure from such principles. Therefore, this invention includes all modifications encompassed within the scope of the following claims.

1. A control arm for use with a vehicle suspension comprising:
a first elongated channel section having a first end and a second end, said first channel section including an upper flange portion, a lower flange portion and a web portion, said first elongated channel section having an aperture in each of said first and second ends, said aperture extending transversely through said web portion;
a second elongated channel section having first and second ends, said second channel section including an upper flange portion, a lower flange portion and a web portion, said second elongated channel section having an aperture in each of said first and second ends, said aperture extending transversely through said web portion, said web portion of said second elongated channel section placed adjacent and connected to said web portion of said first elongated channel section wherein the respective apertures on the first and second ends of the first and second channel sections are aligned with one another; and
an isolator positioned and secured within the apertures on said first and second ends of said first and second channel sections.

2. A control arm as set forth in claim 1 including a recess in the inner side of said web portion of at least one of said first and second elongated channel sections.

3. A control arm as set forth in claim 1 including a recess in the inner side of said web portion of both of said first and second elongated channel sections, said recesses cooperating together when said first and second elongated channel sections are placed adjacent to form a passageway.

4. A control arm as set forth in claim 1 wherein said isolator includes:
an outer bushing;
a flexible member disposed within said outer bushing, said flexible member having a passageway therein; and
an inner bushing disposed within said passageway in said flexible member.

5. A control arm as set forth in claim 3 wherein said recess in the inner side of said web portion of both said first and second elongated channel sections is semi-circular and accordingly forms a cylindrical passageway extending longitudinally along at least a portion of said first and second elongated channel sections.

6. A control arm as set forth in claim 1 including a flange member extending outwardly from said aperture, said flange member engaging said isolator when said isolator is positioned and secured within said aperture.

7. A control arm as set forth in claim 6 wherein said the isolator includes an outer bushing, said outer bushing engaging said flange member extending outwardly from said aperture wherein said isolator is positioned and secured within said aperture.

8. A control arm for use with a vehicle suspension comprising:
a pair of elongated members, a portion of each of said members having a channel section including an upper flange portion, a lower flange portion and a web portion, said web portion having an indentation formed therein such that a part of said web portion is deflected outwardly in the direction of said flange portions, said elongated members placed adjacent one another wherein said respective web portions are situated such that said indentations in said elongated members cooperate to form a longitudinally extending passageway that extends at least a portion of the length of said pair of elongated members, said elongated members having first and second ends, each of said first and second ends having an aperture therein; and
an isolator disposed within said apertures located on said first and second ends.

9. A control arm as set forth in claim 9 wherein said aperture includes at least one circumferential flange member extending outwardly in the direction of the flange member of at least one of said elongated members, said circumferential flange member engaging said isolator to secure said isolator within said aperture.

10. A control arm as set forth in claim 9 wherein said indentation in said elongated members is semi-circular shaped whereby when said pair of elongated members are secured together, said semi-circular shaped indentations cooperate with one another to form a cylindrical passageway.

11. A control arm as set forth in claim 8 wherein the height of the web portion varies between the first and second ends of the elongated members.

12. A control arm as set forth in claim 11 wherein the height of the web portion is less in the middle of the elongated members than at the first and second ends of the elongated members.

13. A control arm as set forth in claim 8 wherein said isolator includes:
an outer bushing;
a flexible member disposed within said outer bushing, said flexible member having a passageway therein; and
an inner bushing disposed within said passageway in said flexible member.

14. A control arm as set forth in claim 8 wherein said apertures on the first and second ends of said pair of elongated members each includes a circumferential flange member extending outwardly from said aperture and said isolator including an outer bushing, said outer bushing press fit into said aperture and engaging said circumferential flange members to secure said isolator in said aperture.

15. A method for forming a control arm for use with a vehicle suspension comprising:
forming a pair of elongated members having upper and lower flanges, a web portion and an indentation in said web portion, said indentation extending outwardly in the direction of said flanges;
positioning said elongated members such that said respective web portions of said pair of elongated members are adjacent to one another;
securing said elongated members to one another; and
inserting an isolator into apertures located at the first and second ends of the elongated members.

16. A method for forming a control arm for use with a vehicle suspension as set forth in claim 15 wherein the step of forming a pair of elongated members includes a step of forming a flange member about the circumferential edge of the apertures located at the first and second ends of each of the elongated members.

17. A method for forming a control arm for use with a vehicle suspension as set forth in claim 15 wherein the step of securing said elongated members to one another includes welding the respective web portions of the elongated members to one another to create a unitary member.

18. A method for forming a control arm for use with a vehicle suspension as set forth in claim 16 including the step of providing said isolator with an outer bushing, and press fitting said outer bushing into said aperture wherein said outer bushing engages said flange members on the circumferential edge of said aperture to secure said isolator within said aperture.

19. A method for forming a control arm for use with a vehicle suspension as set forth in claim 16 wherein the step of forming a pair of elongated members includes stamping the pair of elongated members from at least one precut blank.
